(19) United States
(12) Patent Application Publication
(10) Pub. No.: US 2006/0200649 A1
(43) Pub. Date: Sep. 7, 2006

(54) Data alignment and sign extension in a processor

(75) Inventors: Rajinder P. Singh, Austin, TX (US); Muralidharan S. Chinnakonda, Austin, TX (US); Bhasi Kaithamana, Austin, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/060,142

(22) Filed: Feb. 17, 2005

(51) Int. Cl. G06F 13/38; G06F 15/00

(52) U.S. Cl. 712/220; 710/62

(57) ABSTRACT

A method comprising loading a plurality of data bytes from a data cache in response to a load instruction, determining the most significant bit of at least one of the data bytes using a first logic, arranging at least some of the data bytes onto a data bus using a second logic substantially coupled in parallel with the first logic, and performing a sign extension on the data bus using the second logic.

### BACKGROUND

A processor uses load instructions to read data from memory. The data that is loaded from the memory generally is loaded in groups of bits. For example, the data may be loaded in groups of 8 bits (i.e., a byte), 16 bits (i.e., a half-word), or 32 bits (i.e., a word). After being loaded, the data is aligned, bit-extended, and transferred to the processor for arithmetic manipulation by way of, for example, a 32-bit data bus. The following example assumes a 32-bit data bus.

Data alignment involves preferably right-aligning (or possibly left-aligning) the data bits in the data bus. For example, as shown in FIG. 1a, if 8 data bits 100 are loaded, then the 8 data bits 100 are right-aligned in the 32-bit data bus 102, so that the 8 rightmost bit spaces 104 in the data bus 102 are occupied. As such, the 24 leftmost bit spaces 106 are unoccupied.

After the 8 data bits 100 are aligned in the data bus 102, the 24 leftmost bit spaces 106, which are unoccupied, are filled with placeholder bits in a process known as bit-extension. Bit-extension generally is performed when the data loaded is less than the width of the data bus (32 bits). Referring to FIG. 1b, one type of bit-extension is sign-extension, where the leftmost data bit 108 (i.e., the most significant bit of the 8 data bits 100) is reproduced into all of the 24 leftmost bit spaces 106. In this way, the entire data bus 102 is filled with bits. For example, as shown in FIG. 1b, the leftmost data bit 108 is a “1.” Accordingly, using sign-extension, all of the 24 leftmost bit spaces 106 are filled with “1” bits. The data is then allowed to be transferred to the processor for arithmetic manipulation. Another type of bit-extension is zero-extension in which the 24 leftmost bit spaces 106 are filled with “0” bits regardless of the value of the leftmost data bit 108.

Because they are separate processes, data alignment and bit-extension are difficult to perform in the same clock cycle. Often, multiple clock cycles must be used to perform both the processes, resulting in undesirably poor performance.

### SUMMARY

The problems noted above are solved in large part by a high performance method for data alignment and sign extension and a device for performing the same. At least one illustrative embodiment may be a method comprising loading a plurality of data bytes from a data cache in response to a load instruction, determining the most significant bit of at least one of the data bytes using a first logic, arranging at least some of the data bytes onto a data bus using a second logic substantially coupled in parallel with the first logic, and performing a sign extension on the data bus using the second logic.

Yet another illustrative embodiment may be a device for aligning data and performing bit extensions comprising a first logic adapted to, within a single clock cycle, arrange multiple data bytes onto a data bus and to, within said clock cycle, perform a bit extension on the data bus. A second logic is coupled to the first logic and is adapted to provide to the first logic the most significant bit of at least one of said multiple data bytes.

Yet another illustrative embodiment may be a device comprising a first logic adapted to arrange multiple data bytes onto a data bus and to perform a bit extension on the data bus, and a second logic substantially coupled in parallel to the first logic, the second logic adapted to provide the first logic with the most significant bit of at least one of the multiple data bytes.

Still yet another illustrative embodiment may be a communication system comprising an antenna and a processor coupled to the antenna, wherein the processor, in response to a load instruction and within approximately one clock cycle, arranges multiple data units onto a data bus and performs a bit extension on the data bus.

### BRIEF DESCRIPTION OF THE DRAWINGS

For a detailed description of exemplary embodiments of the invention, reference will now be made to the accompanying drawings in which:

FIG. 1a shows a block diagram of 8 data bits right-aligned in a 32-bit data bus;

FIG. 1b shows a block diagram of the bit-extension of the data bus in FIG. 1a;

FIG. 2 shows a block diagram of a processor comprising a load/store unit that aligns data and performs bit-extensions in parallel, in accordance with a preferred embodiment of the invention;

FIG. 3a shows a detailed block diagram of the load/store unit of FIG. 2, in accordance with embodiments of the invention;

FIG. 3b shows a 128-bit result bus in accordance with embodiments of the invention;

FIG. 3c shows the 32-rightmost bit spaces of the 128-result bus of FIG. 3b, in accordance with embodiments of the invention;

FIGS. 4a-4c show a circuit schematic of the load/store unit of FIG. 3a, in accordance with a preferred embodiment of the invention;

FIG. 5 shows a flow diagram describing a method that may be implemented in the load/store unit of FIGS. 4a-4c, in accordance with embodiments of the invention; and

FIG. 6 shows an illustrative embodiment of a system containing the features described in FIGS. 2-5, in accordance with embodiments of the invention.

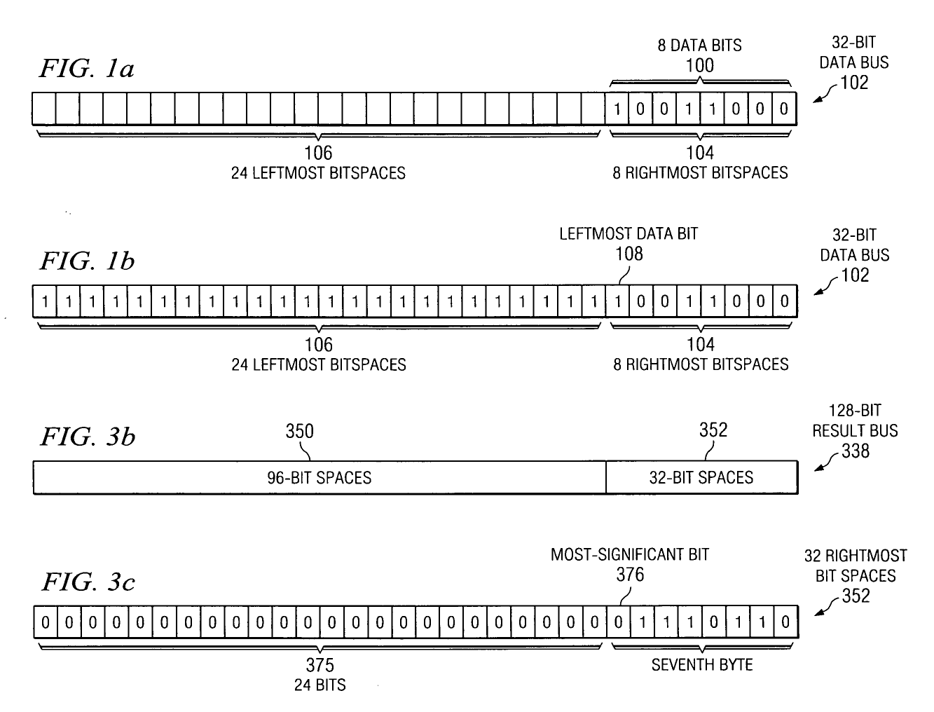

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. Further, the term “target data” or “targeted data” refers to data that is requested by an instruction, such as a load instruction.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Disclosed herein is a process and apparatus by which data may be both aligned and bit-extended preferably in a single clock cycle, thus substantially improving processor performance over other data alignment and bit-extension techniques. As described below, data alignment and bit-extension are performed simultaneously (i.e., in parallel), thus enabling both processes to be performed within a single clock cycle.

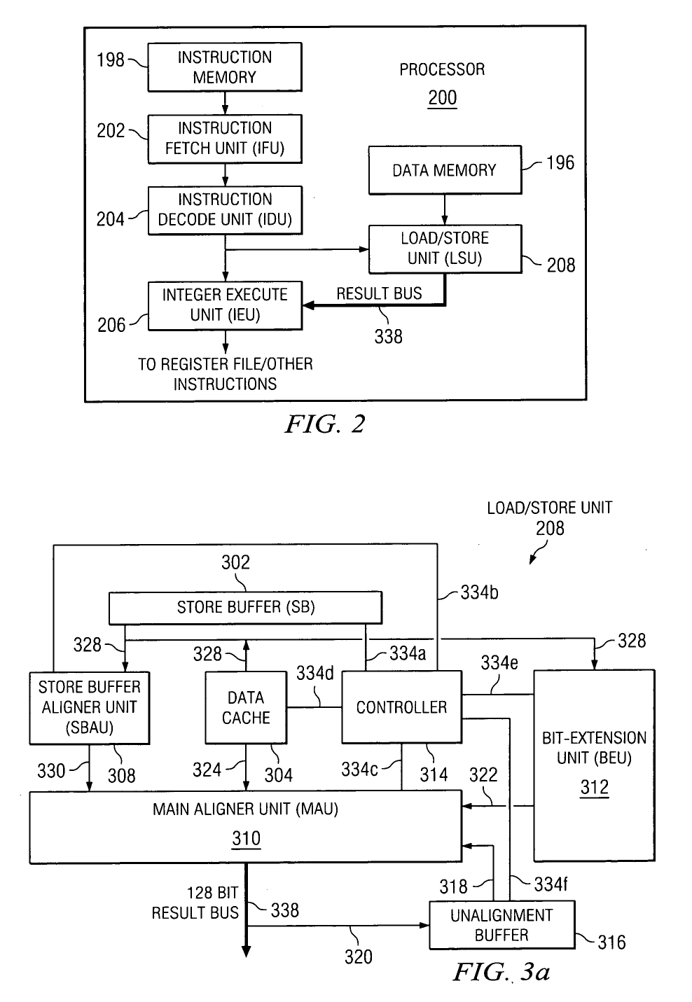

FIG. 2 shows a processor 200 that comprises, among other things, an instruction memory 198, a data memory 196, an instruction fetch unit (IFU) 202, an instruction decoder unit (IDU) 204, an integer execute unit (IEU) 206 and a load/store unit (LSU) 208. The IFU 202 fetches instructions from the memory 198 that are to be executed by the processor 200. The IDU 204 decodes the instructions and, based on the type of the instructions, routes the instructions accordingly. For example, an instruction that requires an arithmetic operation, such as an addition operation, may be routed to the IEU 206. Instructions that require data to be loaded from, or stored into, storage (such as a data cache, not specifically shown) may be routed to the LSU 208. For instance, if the instruction is a load instruction, then the target data is fetched using the LSU 208 and is sent via result bus 338 to the IEU 206 to be used in arithmetic operations.

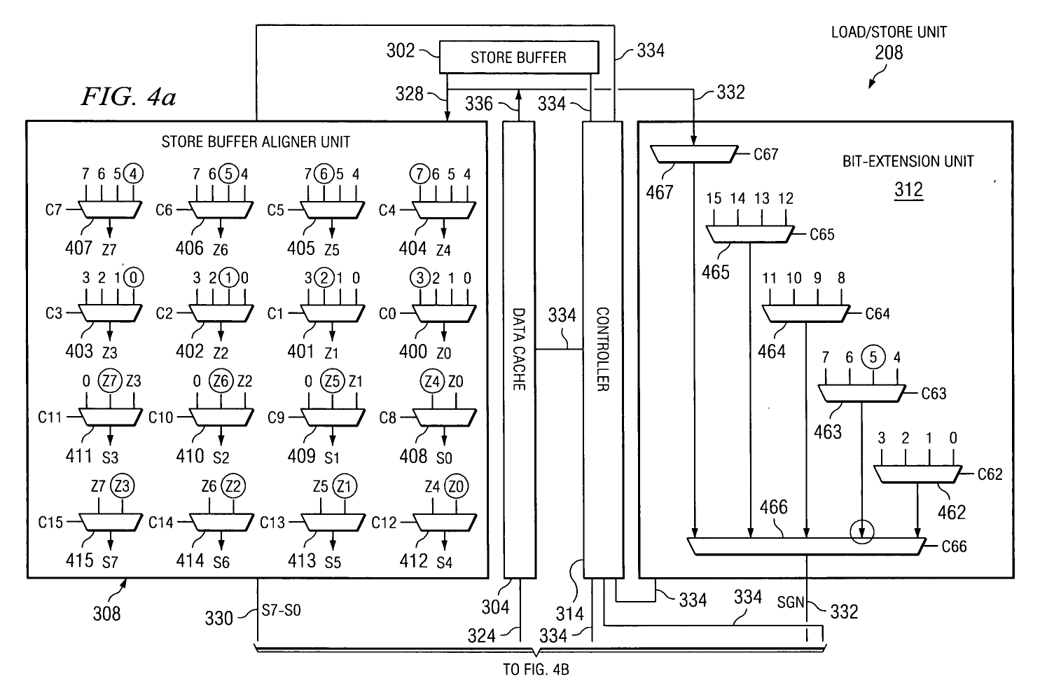

FIG. 3a shows a detailed block diagram of the LSU 208. The LSU 208 comprises, among other things, a store buffer (SB) 302, a data cache 304, an SB aligner unit (SBAU) 308 coupled to the SB 302 by way of data bus 328, and a main aligner unit 310 coupled to the SBAU 308 via data bus 330 and to the data cache 304 via data bus 324. The LSU 208 also comprises an unalignment buffer 316 coupled to the main aligner unit 310 via data buses 338, 320 and feedback loop 318. Further, the LSU 208 comprises a bit extension unit (BEU) 312 that is provided with data from the SB 302 and the data cache 304 via data bus 328. The BEU 312 outputs data to the main aligner unit (MAU) 310 via data bus 322. Data that is aligned and bit-extended in the MAU 310 may be output to the IEU 206 via a 128-bit result bus 338. Although, in the embodiments discussed herein, the result bus 338 is shown to be 128 bits wide, in other embodiments, the width of the result bus 338 may be different. Further still, the LSU 208 may comprise a controller 314 that is coupled to the SB 302, the SBAU 308, the MAU 310, the data cache 304, the BEU 312, and the unalignment buffer 316 by way of data buses 334a-334f, respectively.

The data cache 304 stores copies of data recently fetched from a data memory 196 and may be of any suitable size. Data retrievals from the data cache 304 generally are faster than data retrievals from memory. As such, the presence of the data cache 304 improves processor performance by supplying data for load operations faster than the data can be loaded from memory. The SB 302 is primarily used during store operations. Data that is to be stored in a store operation generally is speculative in nature (i.e., there may still be branches, exceptions, etc.) and thus the data cannot be committed to memory or to a data cache. As such, before data is stored to the data cache 304, it is first temporarily stored to the SB 302 so that speculative data is not stored into the data cache 304. Only when it is determined by the controller 314 that data in the SB 302 can safely be stored to the data cache 304 (i.e., the data is non-speculative and there are no branches, exceptions, etc.) is the data actually stored to the data cache 304.

The data cache preferably is organized as a plurality of “lines” that are 16 bytes (i.e., 128 bits) each. Data is preferably loaded from the data cache 304 one line (e.g., 16 bytes) at a time. Although a load instruction received by the controller 314 from the IDU 204 may specify less than 16 bytes of data be loaded, data may still be loaded 16 bytes at a time: the target data plus additional data (i.e., the entire “cache line”). Thus, not all of the data that is loaded from the data cache 304 is data targeted by the load instruction. The MAU 310 organizes the 128 bits (i.e., 16 bytes) of data loaded from the data cache 304. For example, the MAU 310 may extract and separate the data targeted by the load instruction from the remainder of the 16 data bytes.

FIG. 3b shows the 128-bit result bus 338 in greater detail. In at least some embodiments, the 128 bits of the result bus 338 are divided into multiple portions, each portion containing data bits intended for different logic in the processor 200. As shown in the figure, the 32 rightmost bit spaces 352 preferably are reserved for data targeted by the load instruction. The rest of the data bits (i.e., the 96 leftmost bit spaces 350) may contain the remainder of the 16 data bytes loaded from the data cache 304. Data bits in these bit spaces 350 may be used by other logic on the processor 200 as necessary.

Different load instructions require different amounts of data from the data cache 304. One load instruction might require 8 bits, another might require 16 bits, and yet another load instruction might require 32 bits. In the case of a load instruction that requires 32 bits to be loaded from the data cache 304, no bit extension needs to be performed on the 32 rightmost bit spaces 352, since all of these bit spaces 352 are filled with target data.

However, in the case of load instructions targeting less than 32 bits (e.g., 16 bits or 8 bits), all of the 32 rightmost bit spaces 352 are not filled with the target data. More specifically, although such load instructions require less than the 32 bit spaces 352 reserved for target data, 128 bits (i.e., 16 bytes) are still loaded each time the data cache 304 is accessed. Thus, because the bit spaces 352 are reserved for target data, and there may be only 8 bits or 16 bits of target data, some of the bit spaces 352 may be left vacant. For example, if 8 bits of data are targeted by the load instruction, 128 bits of data will still be loaded from the data cache 304. However, only 8 bits of these 128 bits will be used for the load instruction. The remaining 120 bits will be used by other logic for other purposes. The 8 data bits targeted by the load instruction are assigned to the 8 rightmost bit spaces within the bit spaces 352. Naturally, some of these 120 bits (i.e., 24 bits) will be discarded as deemed appropriate by the controller 314. Because the bit spaces 352 are reserved for target data, preferably only the 8 data bits targeted by the load instruction are assigned to 8-bit spaces within the 32-bit spaces 352. The remaining 24 bit spaces 352 are left vacant. In at least some embodiments, less than 128 bits may be retrieved from each data cache access, such as for power conservation. Also, because a preferable maximum of 32 bits is occupied by target data, the remaining 96 bits may be used by other system units, as mentioned above, or the 96 bits may be discarded.

As mentioned above, if the 32 rightmost bit spaces 352 are all occupied by data targeted by the load instruction, no bit extension is performed. However, in the case of a load operation that requires only 8 bits or 16 bits, a bit extension is performed to fill the vacant 24 bits or 16 bits within the 32 rightmost bit spaces 352. More specifically, the controller 314 determines whether the most significant bit (i.e., the leftmost data bit) in the 32 rightmost bit spaces 352 is a “0” or a “1.” For example, if the bit spaces 352 contain only 8 bits of target data, then the controller 314 checks the status of the most significant bit (i.e., 8^{th} bit from the right). Similarly, if the bit spaces 352 contain only 16 bits, then the controller 314 checks the status of the most significant bit (i.e., 16^{th} bit from the right). In either case, if the most significant bit is a “0,” then the controller 314 causes the BEU 312 to fill any vacant bit spaces 352 with “0” bits. Similarly, if the most significant bit is a “1,” then the controller 314 causes the BEU 312 to fill any vacant bit spaces 352 with “1” bits.

At the time that the 128 bits are loaded from the data cache (i.e., within the same clock cycle), the BEU 312 is supplied with a copy of the most significant bit of each of the 16 bytes. Thus, the BEU 312 is supplied with at least 16 bits. The BEU 312 is supplied with the most significant bit of each of the 16 bytes because the data targeted by the load instruction has not yet been separated from data not targeted by the load instruction. For example, a load instruction requires 8 bits of data from the data cache 304. Of the 16 bytes of data loaded from the data cache 304 at a time, the targeted 8 bits are found in the 7^{th} byte. Accordingly, the BEU 312 uses the most significant bit of the 7^{th} data byte to perform the sign extension. Thus, as shown in FIG. 3c, the 32 rightmost bit spaces 352 may be filled with the 7^{th} byte of the 16 bytes from the data cache, where the 7^{th} byte is right-aligned. The remaining 24 bits 375 of the bit spaces 352 are all filled with copies of the most significant bit 376 of the 7^{th} data byte. In this case, the most significant bit 376 of the 7^{th} data byte is a “0.” Accordingly, 8 of the bit spaces 352 are filled with the data targeted by the load instruction (i.e., the 7^{th} byte), and the remainder of the bit spaces 352 are filled with “0” bits.

A load instruction may comprise the data cache address where the data targeted by the load instruction may be found. However, in cases where the SB 302 is storing data destined for the same data cache address as that specified by the load instruction, data may be loaded from the SB 302 instead of the data cache 304 (known as “store buffer forwarding”). In this way, the most current data intended for that particular address is retrieved, instead of the less recent data that may be found at that address in the data cache 304. This data loaded from the SB 302 is aligned by the SBAU 308 and then the aligned bits are transferred to the MAU 310 via the data bus 330. In the MAU 310, these data bits then are aligned onto the result bus 338 along with any other bits from the data cache 304, as described in further detail below.

As mentioned above, data is loaded from the data cache 16 bytes at a time. In some cases (“overlap conditions”), due to its location in the data cache, part of the data targeted by a load instruction may be included in a first 16-byte load, and the remainder of the target data may be included in a second (i.e., subsequent) 16-byte load. For example, a load instruction may require 2 bytes of data from the data cache 304 in two different lines. Accordingly, 16 bytes are loaded from the data cache 304 in a first line. The 16^{th} byte may be one of the bytes of target data. This byte is temporarily stored in the unalignment buffer 316. The other byte of the target data is still in the data cache 304 in a second line. Thus, to retrieve the other target data byte, a second 16-byte load from the data cache 304 is performed. While this second 16-byte load is being performed, the first byte that is stored in the unalignment buffer 316 is routed back to the MAU 310 via the data bus 318. In this way, the MAU 310 is provided with both of the target data bytes at the same time. The MAU 310 then may align both data bytes on the 128-bit result bus 338 as necessary. Data on the result bus 338 then is forwarded to the IEU 206 for further processing.

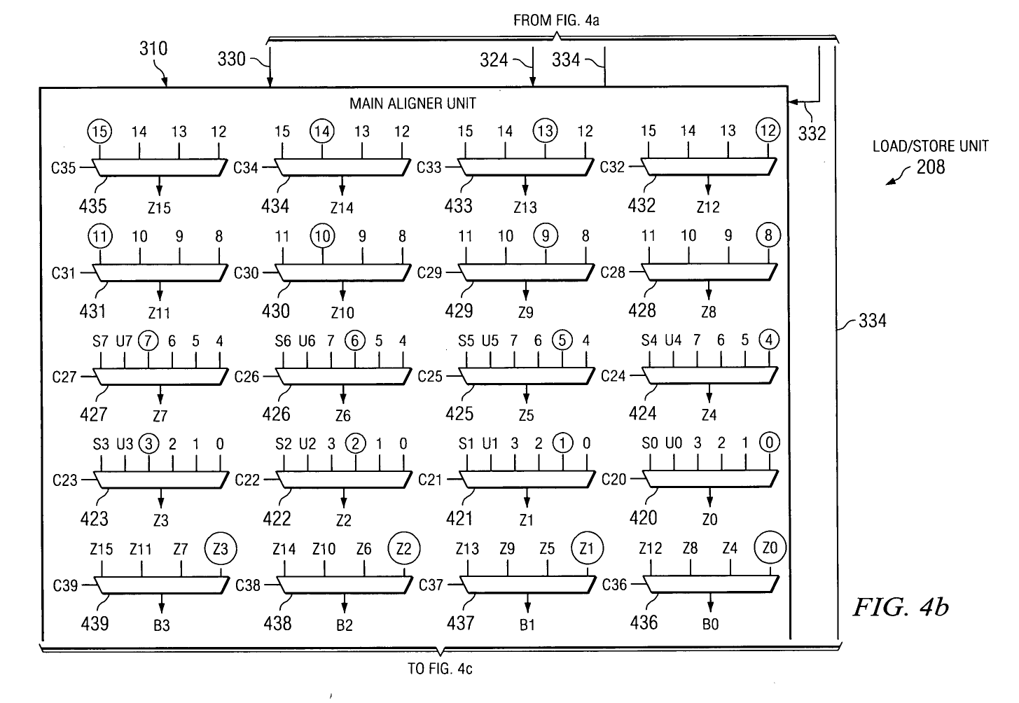

FIGS. 4a-4c show a detailed circuit schematic of the LSU 208. Referring to FIGS. 4a-4c, the SBAU 308 of the LSU 208 comprises a plurality of multiplexers 400-415. The SBAU 308 is provided with 8 bytes of data at a time from the SB 302. Inputs to the multiplexers 400-403 include bytes 0-3. Inputs to the multiplexers 404-407 include bytes 4-7. The outputs of multiplexers 400-403 are labeled z0-z3, respectively. The outputs of multiplexers 404-407 are labeled z4-z7, respectively. Inputs to the multiplexer 408 include z0 and z4. Inputs to the multiplexers 409 include 0, z5 and z1. Inputs to the multiplexer 410 include 0, z6 and z2. Inputs to the multiplexer 411 include 0, z7 and z3. Inputs to the multiplexer 412 include z0 and z4. Inputs to the multiplexer 413 include z1 and z5. Inputs to the multiplexer 414 include z2 and z6. Inputs to the multiplexer 415 include z3 and z7. Outputs of the multiplexers 408-415 are labeled S0-S7, respectively. Control signals C0-C15 are provided to the multiplexers 400-415, respectively, by the controller 314.

The 8 data bytes sent from the SB 302 to the SBAU 308 during a store buffer forwarding process are aligned by the SBAU 308 before being output to the MAU 310. For example, the 8 data bytes may be referred to as 0-7 and may arrive at the SBAU 308 in the order 0-7. However, in this example, the bytes may need to be output to the MAU 310 in the order 7-0. Accordingly, as indicated by the circles around some of the multiplexer input signals, the controller 314 adjusts multiplexer control signals such that the output z0 of the multiplexer 400 is byte 3, the output z1 of the multiplexer 401 is byte 2, the output z2 of the multiplexer 402 is byte 1, the output z3 of the multiplexer 403 is byte 0, the output z4 of the multiplexer 404 is byte 7, the output z5 of the multiplexer 405 is byte 6, the output z6 of the multiplexer 406 is byte 5, and the output z7 of the multiplexer 407 is byte 4.

The outputs of the multiplexers 408-415 are selected such that the 8 bytes input into the SBAU 308 (i.e., in the order 0-7) are output on the output bytes S0-S7 in the order 7-0. Specifically, the control signals to the multiplexers 408-415 are chosen by the controller 314 such that the output S0 of the multiplexer 408 is z4 (i.e., as explained above, z4 is the same as the output of multiplexer 404, which is byte 7), the output S1 of the multiplexer 409 is z5 (i.e., byte 6), the output S2 of the multiplexer 410 is z6 (i.e., byte 5), the output S3 of the multiplexer 411 is z7 (i.e., byte 4), the output S4 of the multiplexer 412 is z0 (i.e., byte 3), the output S5 of the multiplexer 413 is z1 (i.e., byte 2), the output S6 of the multiplexer 414 is z2 (i.e., byte 1), and the output S7 of the multiplexer 415 is z3 (i.e., byte 0). Thus, the 8 bytes from the SB 302 were input into the SBAU 308 in the order 0-7, and the multiplexers 400-415, using control signals from the controller 314, rearrange the 8 bytes so that the output bytes S0-S7 are in the order 7-0.

The MAU 310 functions in a manner similar to the SBAU 308. The output bytes S0-S7 are input into the MAU 310 from the SBAU 308, in the case of a store buffer forwarding situation as previously described. However, in most cases, data that is aligned by the MAU 310 is retrieved from the data cache 304, preferably 16 bytes at a time. These 16 bytes may be referred to as 0-15. Still referring to FIGS. 4a-4c, the MAU 310 comprises multiplexers 420-451. The inputs to the multiplexers 420-423 may comprise, among others, bytes 0-3. The inputs to multiplexers 424-427 may comprise, among others, bytes 4-7. The inputs to multiplexers 428-431 may comprise, among others, bytes 8-11. The inputs to multiplexers 432-435 include bytes 12-15. The outputs of multiplexers 420-435 are z0-z15, respectively. In cases of store buffer forwarding, however, the outputs z0-z7 of multiplexers 420-427 may be superceded by some or all of the bytes S0-S7 from the SBAU 308 (i.e., inputs S0-S7).

The multiplexers 436, 440 are provided with inputs z0, z4, z8 and z12. The multiplexers 437, 441 are provided with inputs z1, z5, z9 and z13. The multiplexers 438, 442 are provided with inputs z2, z6, z10 and z14. The multiplexers 439, 443 are provided with inputs z3, z7, z11 and z15. The multiplexers 444-451 are provided with inputs z8-z15, respectively. Each of the multiplexers 400-451 is provided with a control signal C0-C51, respectively, from the controller 314.

The controller 314 assigns control signals to the multiplexers 420-451 such that the 16 data bytes loaded from the data cache 304 are rearranged and aligned as needed by the load instruction. For example, a load instruction requests bytes 0, 1, 2 and 3 (i.e., 32 bits) from the data cache 304. Accordingly, 16 bytes are first loaded from the data cache 304 into the MAU 310. The controller 314 sends control signals to the multiplexers 420-435 such that multiplexers 420-435 allow input bytes 0-15 to pass through, respectively (as indicated by the circles). Because the load instruction requires data bytes 0, 1, 2 and 3, the bytes 0, 1 2 and 3 are taken from the multiplexers 420-423 as outputs z0-z3 and are input to the multiplexers 436-439, whereby they pass through the multiplexers 436-439, respectively (as indicated by the circles). In this way, the target 32 data bits (i.e., 4 bytes) are assigned to the 32 rightmost bit spaces 352 of the 128-bit result bus 338. Referring at least to FIG. 3b, because all of the bit spaces 352 are full, there is no need for a bit extension to be performed. The remaining 96 leftmost bit spaces 350 are assigned values by the multiplexers 440-451. Multiplexers 440-451 may allow byte inputs z4-z15 to pass through, respectively (as indicated by the circles), although any other suitable arrangement of bytes in the 96 leftmost bit spaces 350 may be used. Once the result bus 338 is full of 128 bits, the data on the result bus 338 is transferred to other logic on the processor 200, such as the IEU 206, for further processing.

As mentioned above, because the 32 rightmost bit spaces 352 all were filled with target data bits, there was no need for a bit (e.g., sign) extension to be performed. However, if the load instruction requests only 16 bits, for example, then a sign extension may be performed. For example, a load instruction requires data byte 5 to be loaded from the data cache 304 and sent to the IEU 206. Accordingly, 16 bytes are loaded from the data cache 304. Multiplexers 420-423 may allow any suitable bytes to pass through, except for byte 5. Multiplexer 424 may allow the data byte 5 to pass through. Multiplexers 425-435 may allow any suitable bytes to pass through, except for byte 5 (not indicated by a circle). The controller 314 outputs control signals to the multiplexer 436 such that the output z4 (i.e., byte 5) of the multiplexer 424 passes through. Because the load instruction only targets 1 byte of data, and because the 32 rightmost bit spaces 352 of the result bus 338 are reserved for target data, the multiplexers 437-439 may allow no bytes to pass through, thus leaving 24 of the 32 rightmost bit spaces 352 vacant. The controller 314 also may set control signals to the multiplexers 440-451 such that any suitable combination of data bytes passes through.

Because 24 of the 32 rightmost bit spaces 352 are vacant, a sign extension is performed to fill these 24 bit spaces 352. A sign extension is performed using the BEU 312. The BEU 312 comprises, among other things, data cache sign bit alignment multiplexers 462-465. The outputs of the multiplexers 462-465 are coupled to the inputs of the multiplexer 466. The multiplexers 462-465 are provided with a total of 16 bits as inputs. The multiplexers 462-465 also are provided with control signals C62-C65 from the controller 314. Specifically, the multiplexer 462 has the most significant bits of bytes 0-3 as inputs. The multiplexer 463 has the most significant bits of bytes 4-7 as inputs. The multiplexer 464 has the most significant bits of bytes 8-11 as inputs. The multiplexer 465 has the most significant bits of bytes 12-15 as inputs. Each of these 16 bits is a copy of the most significant bit of each of the 16 bytes loaded from the data cache 304. Because sign extension is performed by filling vacant bit spaces 352 with the most significant bit of the target data in the 32 rightmost bit spaces 352 (e.g., most significant bit 376 in FIG. 3c), each of these 16 bits is kept ready to be supplied to the MAU 310. Which of these 16 bits is actually supplied to the MAU 310 depends on the most significant byte in the 32 rightmost bit spaces 352. Continuing with the previous example, byte 5 is stored in the bit spaces 352 (right-aligned). The remaining 24 bits in the bit spaces 352 are vacant. In a sign extension process, these 24 bits may be filled with copies of the most significant bit of byte 5. The most significant bit of byte 5 is supplied as an input to the multiplexer 463. As indicated by the circle around the input corresponding to the most significant bit of byte 5, the multiplexer 463 allows the most significant bit of byte 5 to pass through. The multiplexer 466 then chooses the output of multiplexer 463 (i.e., the most significant bit of byte 5) as the input signal that is allowed to pass through the multiplexer 466, based on a control signal C66 provided by the controller 314. Thus, the most significant bit of byte 5 is supplied to the MAU 310. The MAU 310 reproduces the most significant bit of byte 5 and fills each of the vacant bit spaces 352 with copies of the most significant bit of byte 5, thus completing the sign extension process. A similar process may be used for load instructions that require 16 bits of data from the data cache 304.

In the case of a store buffer forwarding scenario, for example, the multiplexer 436 may allow the output of the multiplexer 420 to pass through the multiplexer 436. The output of the multiplexer 420 may, in this store buffer forwarding case, be byte S0 from the SBAU 308 (not circled in the figure). Furthermore, the remaining 32 rightmost bit spaces 352 may be left vacant (i.e., the load instruction only targeted 1 byte of data). Thus, a sign extension may be performed. To perform a sign extension, a copy of the most significant of byte S0 may be targeted to fill the vacant bit spaces in the bit spaces 352. This most significant bit of byte S0 may be available from the multiplexer 467, which is controlled by the controller 314 using a control signal C67. The multiplexer 467 receives as inputs the most significant bit of each of the 8 bytes transferred from the SB 302 to the SBAU 308. Thus, if the MAU 310 requires the most significant bit of byte S0, then the controller 314 issues control signals to the multiplexers 467, 466 causing the multiplexers 467, 466 to allow the most significant bit of S0 to pass through the multiplexers 467, 466 to the MAU 310. Upon arrival at the MAU 310, the most significant bit of S0 is used to fill the vacant bit spaces in the 32 rightmost bit spaces 352. Similarly, if the MAU 310 requires the most significant bit of byte S6, then the controller 314 issues control signals to the multiplexers 467, 466 causing the multiplexers 467, 466 to allow the most significant bit of S6 to pass through the multiplexers 467, 466 to the MAU 310. The MAU 310 fills vacant bit spaces in the 32 rightmost bit spaces 352 with copies of the most significant bit of S6. Because the data alignments performed in the MAU 310 (and/or the SBAU 308) occur in parallel with the sign extension selections performed by the BEU 312, only one clock cycle is needed, thus providing substantial performance advantages over other data alignment and sign extension techniques.

As described above, in some cases, due to the locations of various data bytes in the data cache 304, one 16-byte data loaded may not be sufficient to gather all of the data targeted by a load instruction. For example, during a first clock cycle, 16 data bytes are loaded from the data cache 304. Only one of the two targeted bytes is present in these 16 bytes. This data byte is aligned by the MAU 310 and is stored in the unalignment buffer 316. In a second clock cycle, another 16 data bytes are loaded from the data cache 304. At the same time, the first targeted byte stored in the unalignment buffer 316 is sent back to the MAU 310 as byte U0. In this way, MAU 310 has both the first and second targeted bytes. Instead of feeding one of the inputs of multiplexers 420 (e.g., 0, 1, 2, 3, S0) into the multiplexer 436, the controller 314 may feed the multiplexer 436 the byte U0 from the multiplexer 420 instead (not circled in the figure). Likewise, the controller 314 may adjust the multiplexer control signals such that the multiplexer 437 is fed the second targeted data byte. In this way, the first and second targeted data bytes are properly aligned in the 32 rightmost bit spaces 352. Within the second clock cycle, the bit spaces 352 may be sign extended and other multiplexer inputs may be chosen as desired. Once the result bus 338 is filled, the data may be output to the IEU 206 for further processing.

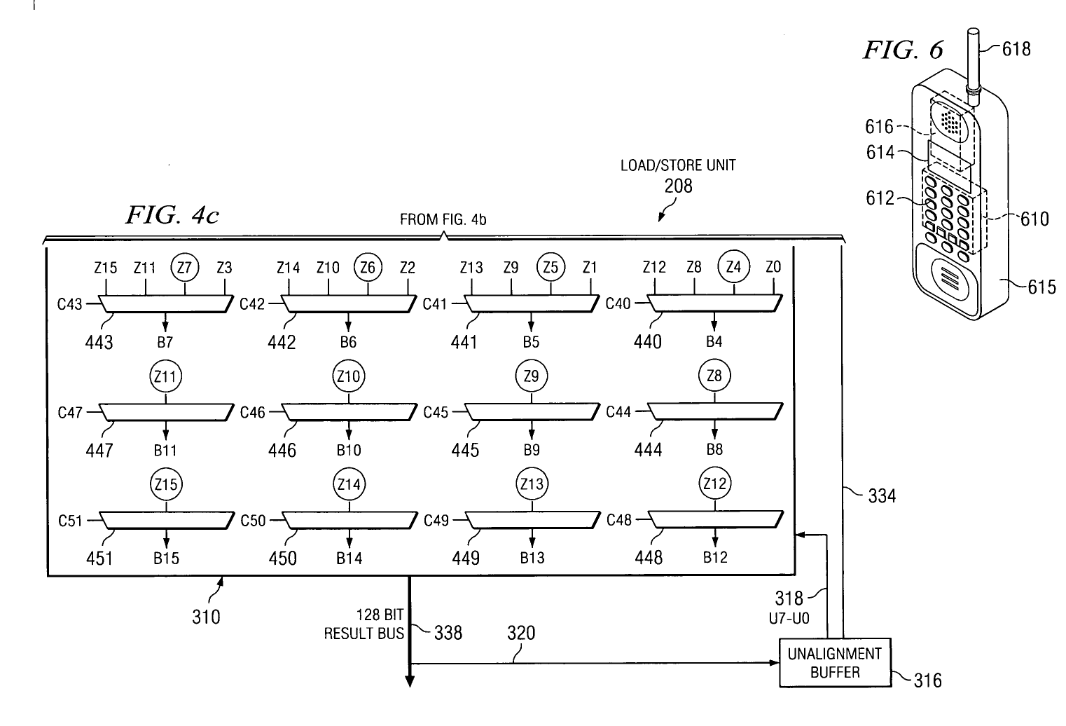

FIG. 5 shows a flow diagram of the process described above. The process may begin by receiving a load instruction that includes the address of the target data (block 500). The instruction may be received from, for example, an instruction decode unit or some other such unit. The process may continue by determining whether the address of the target data corresponds with any data entries in the store buffer (block 502). If the address indeed corresponds with data entries in the store buffer, then a store buffer forwarding scenario occurs, whereby 8 bytes of data are retrieved from the store buffer and aligned in a store buffer aligner. At the same time, the process comprises preparing the most significant bit of each of the 8 bytes for a possible sign extension (block 504). The 8 bytes subsequently may be passed to the main aligner (block 506). Regardless of whether the address corresponds with data entries in the store buffer, the process may continue by receiving into the main aligner either the 8 bytes from the store buffer (i.e., in a store buffer forwarding scenario) or 16 bytes fetched from the data cache. At the same time, the process may begin preparing the most significant bit of each of the 16 bytes or may continue preparing the most significant bits of the 8 bytes, depending on whether data is loaded from the store buffer or from the data cache (block 508).

The process may continue by determining whether all of the data targeted by the load instruction is available to the main aligner (block 510). If all of the targeted data is available, then the process may align the data bytes in the main aligner, performing a sign extension if necessary (block 516). The data then may be output onto the result bus (block 518). Otherwise, if all of the targeted data is not available, then the process may comprise storing whatever data is currently available in an unalignment buffer (block 512). The process then may perform a second load operation from the data cache and also may feed the data in the unalignment buffer back into the main aligner (block 514). Once the main aligner contains the data targeted by the load instruction, the main aligner may align the data bytes, performing a sign extension if necessary (block 516). The data then may be output onto the result bus (block 518) and sent to other logic for further processing.

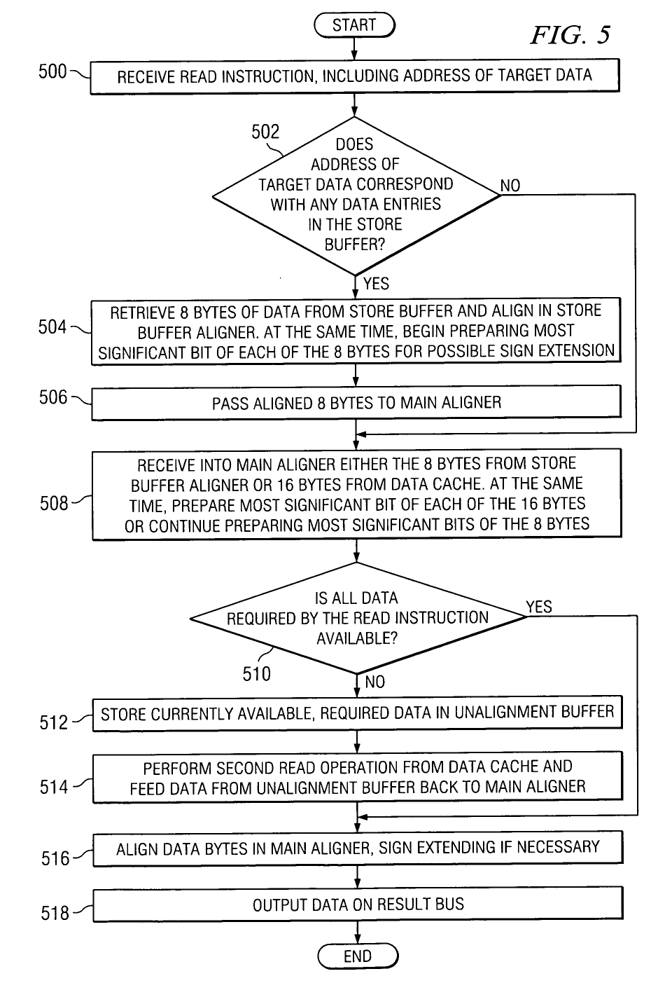

FIG. 6 shows an illustrative embodiment of a system comprising the features described above. The embodiment of FIG. 6 comprises a battery-operated, wireless communication device 615. As shown, the communication device includes an integrated keypad 612 and a display 614. The load/store unit (LSU) 208 and/or the processor 200 comprising the LSU 208 may be included in an electronic package 610 which may be coupled to keypad 612, display 614 and a radio frequency (RF) transceiver 616. The RF circuitry 616 preferably is coupled to an antenna 618 to transmit and/or receive wireless communications. In some embodiments, the communication device 615 comprises a cellular (e.g., mobile) telephone.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method, comprising:
loading a plurality of data bytes from a data cache in response to a load instruction;
using a first logic, determining the most significant bit of at least one of the data bytes;
using a second logic substantially coupled in parallel with the first logic, arranging at least some of the data bytes onto a data bus; and
using the second logic, performing a sign extension on the data bus.

2. The method of claim 1 further comprising loading data from a store buffer and arranging at least some of the data onto the data bus.

3. The method of claim 1 further comprising storing a first data byte in a temporary storage module while a second data byte is loaded from the data cache in response to a second load instruction.

4. The method of claim 3 further comprising using the second logic to substantially simultaneously arrange the first data byte and the second data byte onto the data bus.

5. The method of claim 1 wherein determining the most significant bit, arranging at least some of the data bytes and performing the sign extension comprises determining the most significant bit, arranging at least some of the data bytes and performing a sign extension within approximately one clock cycle.

6. A device for aligning data and performing bit extensions, comprising:
a first logic adapted to, within a single clock cycle, arrange multiple data bytes onto a data bus and to, within said clock cycle, perform a bit extension on the data bus; and
a second logic coupled to the first logic, the second logic adapted to provide to the first logic the most significant bit of at least one of said multiple data bytes.

7. The device of claim 6, wherein the first logic is adapted to perform at least one of a zero extension and a sign extension.

8. The device of claim 6, wherein the first logic and the second logic are substantially coupled in parallel.

9. The device of claim 6 further comprising a buffer module that stores at least some of the multiple data bytes and returns the at least some of the multiple data bytes to the first logic during a subsequent clock cycle.

10. The device of claim 6, wherein the device is located within a wireless communication apparatus.

11. A device, comprising:
a first logic adapted to arrange multiple data bytes onto a data bus and to perform a bit extension on the data bus; and
a second logic substantially coupled in parallel to the first logic, the second logic adapted to provide the first logic with the most significant bit of at least one of said multiple data bytes.

12. The device of claim 11, wherein the first logic arranges the multiple data bytes onto the data bus and performs the bit extension on the data bus within a single clock cycle.

13. The device of claim 11, wherein the first logic performs at least one of a sign extension and a zero extension.

14. The device of claim 11, wherein at least one of the first and second logic comprises a plurality of multiplexers.

15. A communication system, comprising:
an antenna; and
a processor coupled to the antenna;
wherein the processor, in response to a load instruction and within approximately one clock cycle, arranges multiple data units onto a data bus and performs a bit extension on the data bus.

16. The communication system of claim 15, wherein the processor comprises:
a first logic that arranges the multiple data units on the data bus and performs the bit extension on the data bus; and
a second logic coupled in parallel to the first logic, said second logic adapted to provide the first logic with the most significant bit of at least one of the data units.

17. The communication system of claim 15, wherein the processor performs at least one of a sign extension and a zero extension on the data bus.

18. The communication system of claim 15, wherein the communication system is a device selected from a group consisting of a wireless communication device, a mobile telephone, a battery-operated device and a personal digital assistant.
